(19) United States
(12) Patent Application Publication
(10) Pub. No.: US 2016/0018358 A1
(43) Pub. Date: Jan. 21, 2016

(54) ANALYSIS OF SILICON CONCENTRATION IN PHOSPHORIC ACID ETCHANT SOLUTIONS

(71) Applicant: ECI Technology, Inc., Camarillo, CA (US)

(72) Inventors: Eugene Shalyt, Washington Township, NJ (US); Chuannan Bai, Fair Lawn, NJ (US)

(21) Appl. No.: 14/555,662

(22) Filed: Nov. 27, 2014

Related U.S. Application Data
(60) Provisional application No. 62/026,533, filed on Jul. 18, 2014.

(51) Int. Cl. G01N 27/416; G01N 27/403

(52) U.S. Cl. CPC G01N 27/4163; G01N 27/4035

(57) ABSTRACT

Low concentrations of silicon in an etchant solution comprising phosphoric acid, an organo-silicon compound and water are analyzed by adding predetermined concentrations of a carboxylic acid and fluoride ions to a test solution comprising a predetermined volume of the etchant solution, and measuring the potential of a fluoride ion specific electrode (FISE) in the test solution. Reaction with silicon ions in the test solution reduces the concentration of fluoride ions, which are present in stoichiometric excess, so that the silicon concentration of the etchant solution can be determined from the difference between the predetermined and measured concentrations of fluoride ions in the test solution.

### CROSS-REFERENCE TO RELATED APPLICATIONS

This application claims priority to U.S. Provisional Patent Application No. 62/026,533 to Shalyt et al. filed 18 Jul. 2014, which is assigned to the same assignee.

### BACKGROUND OF THE INVENTION

1. Field of the Invention

This invention is concerned with analysis of semiconductor processing solutions, particularly with determination of silicon concentration in silicon wafer etchant solutions.

2. Description of the Related Art

Etching processes are critical to fabrication of both circuitry and semiconductor devices on silicon integrated circuit (IC) chips. In one process, a silicon nitride (Si₃N₄) mask on a layer of silicon dioxide (SiO₂) is patterned etched to expose the underlying silicon/silicon dioxide layer, which is then locally oxidized at high temperature (800-1200° C.) to produce thicker insulating SiO₂ in unmasked areas to electrically isolate subsequently formed MOS (metal oxide semiconductor) transistors. The Si₃N₄ mask can withstand the high temperature but requires a strong etchant operated at high temperature (>150° C.). The Si₃N₄ etching process must be closely controlled to provide complete removal of the Si₃N₄ mask material without excessive etching of the underlying SiO₂ layer. In particular, it is important to control the etch rate of silicon nitride relative to that of silicon dioxide, which is typically designated as the selectivity of the etchant and given as the ratio of the Si₃N₄:SiO₂ etch rates.

Until recently, the Si₃N₄ etchant of the prior art was generally a concentrated solution of phosphoric acid (85 wt. %) operated at a temperature above 150° C. (typically at the boiling point of 165° C.). The etch rate of Si₃N₄ and the selectivity with respect to SiO₂ in this etchant solution depend strongly on the concentration of silicon ions, which are products of the etching process and accumulate in the etchant solution with use. Silicon ions reduce the etch rates of both Si₃N₄ and SiO₂ in the phosphoric acid etchant but tend to improve the selectivity. It is important that the change in the etch rates and selectivity resulting from accumulation of silicon ions be taken into account to optimize the Si₃N₄ etching process but available methods for determining the silicon concentration in concentrated phosphoric acid solutions are often inadequate.

Conventional methods of determining the concentration of silicon ions in aqueous solutions involve reaction of silicon ions with ammonium molybdate to form the ammonium silicomolybdate salt, which is a yellow solid. This reaction is the basis for measuring the concentration of silicon ions by a variety of approaches, including those based on gravimetric, spectroscopic, electrochemical and ion chromatography methods. However, ammonium molybdate also reacts with phosphate ions to form an analogous compound that interferes with determinations of the concentration of silicon ions based on ammonium silicomolybdate. Such interference precludes use of methods based on the ammonium silicomolybdate salt to determine the concentration of silicon ions in Si₃N₄ etchant solutions containing high concentrations of phosphoric acid.

More sophisticated methods, based on atomic absorption analysis or inductively coupled plasma-atomic emission spectroscopy, for example, are available for analysis of silicon ions in concentrated phosphoric acid solution. However, such methods require equipment that is large, complex, expensive and costly to maintain, and are not amenable to automation and on-line use.

European Patent Application No. EP 1724824 A2 to Watatsu et al. (filed 12 May 2006) describes a method for analysis of the silicon ion concentration in Si₃N₄ etchant solutions comprising concentrated phosphoric acid. In this method, HF added as concentrated hydrofluoric acid to the hot phosphoric acid etchant solution reacts with the silicon ions to form gaseous SiF₄, which is hydrolyzed and detected via a change in conductivity of an aqueous solution. This method is cumbersome and time consuming, involves handling a hazardous gas (SiF₄) and is not readily amenable to automation.

As described in U.S. Pat. No. 7,351,349 to Shekel et al. (issued 1 Apr. 2008), near infrared (NIR) spectroscopy may be used to detect silicon ions in some silicon dioxide etchant, surface preparation and cleaning solutions. However, available NIR spectroscopic methods and devices do not provide sufficient sensitivity for analysis of small concentrations of silicon ions in Si₃N₄ etchant solutions.

U.S. Pat. No. 8,008,087 to Shalyt et al. (issued 30 Aug. 2011) describes a practical method for measuring low concentrations of silicon ions in Si₃N₄ etchant solutions comprising concentrated phosphoric acid. In this method, a predetermined concentration of fluoride ions in excess of that required to react with all of the silicon ions present in a test solution is added and the concentration of “free” fluoride ions (those not reacted with silicon ions) is measured, preferably using a fluoride ion specific electrode (FISE). The concentration of silicon ions is calculated from the difference between the predetermined concentration of fluoride ions added to the test solution and the concentration of “free” fluoride ions measured for the test solution. For conventional concentrated phosphoric acid etchants without additives, the method of Shalyt et al. provides sufficiently accurate results within a short time frame using inexpensive equipment so as to enable control of the concentration of silicon ions in the etchant solution via a “bleed and feed” approach, and is amenable to automation and on-line process control.

Fabrication of new semiconductor devices, however, is placing greater demands on both the etching processes and the etchant analysis and control capabilities. Examples of new devices include FinFET transistors with narrow Si₃N₄ spacers and V-N and memory devices with practically rectangular cavities etched into alternating layers of Si₃N₄ while the SiO₂ layers remain substantially intact. Fabrication of such devices requires an Si₃N₄:SiO₂ etching selectively of the order of 1:500 whereas a selectivity of only about 1:300 is provided by conventional concentrated phosphoric acid etchants without additives. The needed Si₃N₄:SiO₂ selectivity may be attained via etchants comprising an organo-silicon compound, phosphoric acid and water.

U.S. Patent Application Publication No. 2013/0092872 A1 to Hong et al. (published 20 Jun. 2013) describes an etching composition comprising phosphoric acid, ammonium ions and an organo-silicate compound having the chemical formula:

R¹—Si—[—O—H]₃

where R¹ is an amino alkyl group or an amino alkoxy group. The organo-silicate compound of Hong et al. may also have the chemical formula:

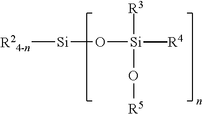

where R², R³, R4 and R⁴ may be hydrogen, an alkyl group, an amino alkyl group or an amino alkoxy group and at least one of which is an amino alkyl group or an amino alkoxy group and n is 2 or 3. Etchants comprising such organo-silicate compounds, phosphoric acid and water provide improved Si₃N₄:SiO₂ etching selectively.

U.S. Patent Application Publication No. 2013/0157427 A1 to Cho et al. (published 18 Apr. 2013) describes an etching composition comprising a silyl phosphate compound, phosphoric acid and deionized water that provides a high Si₃N₄:SiO₂ etching selectivity for fabrication of semiconductor devices. The organo-silicon compound in this case may have the chemical formula:

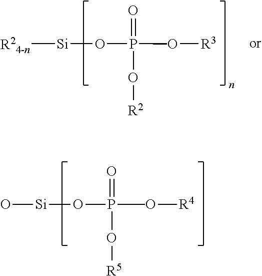

where R1-R5 are defined by Cho et al. and may be hydrogen or selected from a variety of organic functional groups. Etching selectivities of more than 800:1 were provided by some etchant formulations comprising a silyl phosphate compound, phosphoric acid and deionized water.

The method of Shalyt et al. does not provide adequate sensitivity for analysis of silicon ions in such etching compositions comprising phosphoric acid and an organo-silicon compound. Furthermore, particulates tend to precipitate from test solutions of the Shalyt method employed for analysis of etchants comprising an organo-silicon compound and interfere with the silicon ion analysis.

There is a need for an effective method of measuring low concentrations of silicon ions in Si₃N₄ etchant solutions comprising an organo-silicon compound, such as a organo-silicate or silyl phosphate compound, so that the Si₃N₄ etch rate and selectivity can be controlled to improve quality and yield of advanced semiconductor devices. Preferably, the method should provide accurate results within a short time frame using inexpensive equipment, and should be amenable to automation and on-line process control. Environmental impact of the method is also an important consideration.

### SUMMARY OF THE INVENTION

The invention provides an improved method and an apparatus suitable for determining a concentration of silicon ions in a silicon nitride (Si₃N₄) etchant solution comprising an organo-silicon compound (an organo-silicate or a silyl phosphate compound, for example), phosphoric acid and water, as described in U.S. Patent Application Publication No. 2013/0092872 A1 to Hong et al. (published 20 Jun. 2013) and U.S. Patent Application Publication 2013/0157427 A1 to Cho et al. (published 20 Jun. 2013). The etchant solution may further comprise one or more additives, such as surfactants, sequestering agents and anti-corrosion agents.

In the method of the invention, a predetermined concentration of a carboxylic acid and a predetermined concentration of fluoride ions are added to a test solution comprising a predetermined volume of the etchant solution, and the potential of a fluoride ion specific electrode (FISE) in contact with the test solution is measured. In some cases, addition of a predetermined concentration of water to the test solution may be beneficial. The carboxylic acid is preferably acetic acid, propionic acid or mixtures thereof. Silicon ions present in the test solution react with the added fluoride ions so as to reduce the measured concentration of fluoride ions. The predetermined concentration of fluoride ions added to the test solution is chosen to be in stoichiometric excess relative to the silicon ions in the test solution so that the measured FISE potential reflects the concentration of free fluoride ions in the test solution. The difference in the predetermined concentration and the measured concentration of fluoride ions in the test solution corresponds to the concentration of reacted fluoride ions (reacted with silicon ions) in the test solution, which is related to the concentration of silicon ions in the etchant solution.

The apparatus of the invention, which enables automated application of the method of the invention for on-line determination of the concentration of silicon ions in an etchant solution comprising an organo-silicon compound, phosphoric acid and water, comprises: an analysis cell containing a test solution comprising a predetermined volume of the etchant solution and predetermined concentrations of a carboxylic acid and fluoride ions; a means of providing the predetermined volume of the etchant solution; a means of adding the predetermined concentrations of the carboxylic acid and fluoride ions to the test solution; a means of measuring the concentration of fluoride ions in the test solution; and a computing device having a memory element with a stored algorithm operative to effect, via appropriate mechanical and electrical interfacing, at least the basic steps of the method of the invention. The means of measuring the concentration of fluoride ions in the test solution preferably comprises a fluoride ion specific electrode (FISE) in contact with the test solution, a reference electrode in contact with the test solution, and a voltmeter for measuring the potential of the FISE relative to the reference electrode. Fluoride ions are added to the test solution as part of a fluoride compound.

The apparatus of the invention may further comprise: a sampling device operative to flow a predetermined volume of the etchant solution from an etchant container to the analysis cell; and a reagent device operative to flow a predetermined volume of a reagent solution comprising a predetermined concentration of a carboxylic acid and a predetermined concentration of a fluoride compound from a reagent reservoir to the analysis cell. Note that the carboxylic acid and the fluoride compound may be added from separate reagent solutions via separate reagent devices but are preferably contained in a single reagent solution added by a single reagent device. The etchant container may be an etchant reservoir or a production etchant tank. Preferably, the sampling device and the reagent device are controlled by the computing device such that the silicon analysis of the invention may be performed automatically. By flowing the etchant solution at a predetermined etchant solution flow rate through the analysis cell and flowing the reagent solution at a predetermined reagent solution flow rate through the analysis cell, the silicon concentration in the etchant solution may be determined continuously.

The apparatus of the invention may further comprise: a means of rapidly cooling the predetermined volume of the etchant solution to a predetermined temperature so as to shorten the measurement time; and/or a means of measuring and/or controlling the temperature of the test solution so as to minimize and/or correct for the effects of temperature fluctuations on the potential measured for the fluoride ion specific electrode. Preferably, such temperature correction and control functions are performed automatically by the computing device.

The invention is useful for reducing the costs and improving the quality and yield of advanced semiconductor devices by enabling accurate, rapid and cost-effective determination of the concentration of silicon ions in advanced Si₃N₄ etchant solutions comprising an organo-silicon compound, phosphoric acid and water. The steps of the method of the invention are simple to perform, involving standard addition of a carboxylic acid and a fluoride compound to a sample of the etchant solution (possibly diluted with water) and measurement of the fluoride ion concentration in the resulting test solution, preferably via a fluoride ion specific electrode (FISE). A preferred apparatus of the invention, which basically comprises an analysis cell, a FISE, a reference electrode and a voltmeter, is simple, compact and inexpensive, and is readily amenable to on-line use and frequent or continuous measurement of the silicon ion concentration. The environmental impact of the silicon determination of the invention is small since only small amounts of the etchant solution, carboxylic acid and fluoride compound are required.

The invention enables the etch time for Si₃N₄/SiO₂ layers on advanced semiconductor devices to be adjusted to accurately take into account the effect of the concentration of silicon ions in the etchant solution on the Si₃N₄ and SiO₂ etch rates. Accurate measurement of the concentration of silicon ions according to the invention also enables advanced etchant solutions to be replaced based on need rather than a time schedule so as to minimize costs and the amount of waste generated.

Further features and advantages of the invention will be apparent to those skilled in the art from the following detailed description, taken together with the accompanying drawings.

### BRIEF DESCRIPTION OF THE DRAWINGS

FIG. 1 schematically illustrates an apparatus of the invention for determining a silicon concentration in a phosphoric acid etchant solution comprising an organo-silicon compound.

FIG. 2 is a schematic representation of a preferred apparatus of the invention.

FIG. 3 shows plots of the potential of a fluoride ISE versus the concentration of silicon ions in a Si₃N₄ etchant solution (comprising an organo-silicate compound, phosphoric acid and deionized water) measured in test solutions comprising 25.0 mL of the etchant solution and 15.0 mL of a reagent solution comprising 8.0 or 10.0 g/L KF in 100% acetic acid, 100% propionic acid or deionized water.

FIG. 4 shows a plot of the FISE sensitivity to the silicon concentration in an etchant solution versus the volume fraction of a reagent solution B comprising 10.0 g/L KF in 100% acetic acid added to a reagent solution A comprising 10.0 g/L KF in distilled water.

### DETAILED DESCRIPTION OF THE INVENTION

Technical terms used in this document are generally known to those skilled in the art. The term “standard addition” generally means addition of a predetermined quantity of a species to a predetermined volume of a solution (a test solution, for example). The predetermined quantity may be a predetermined weight of the species or a predetermined volume of a standard solution containing the species. A “standard solution” comprises a precisely known concentration of a reagent used for a chemical analysis. The symbol “M” means molar concentration. Calibration data are typically handled as calibration curves or plots but such data may be tabulated and used directly, especially by a computer, and the terms “curve” or “plot” include tabulated data. Water used for solution preparation or dilution is preferably substantially pure water, deionized or distilled water, for example.

The invention provides a method and an apparatus suitable for determining the concentration of silicon ions in a semiconductor etchant solution. The invention may be applied to various etchant solutions but is particularly well-suited for analysis of silicon ions in Si₃N₄ etchant solutions comprising an organo-silicon compound, phosphoric acid and water. U.S. Patent Application Publication No. 2013/0092872 A1 to Hong et al. (published 20 Jun. 2013) describes an advanced Si₃N₄ phosphoric acid etchant comprising an organo-silicate compound. U.S. Patent Application Publication 2013/0157427 A1 to Cho et al. (published 20 Jun. 2013) describes an advanced Si₃N₄ phosphoric acid etchant comprising a silyl phosphate compound. The method of the invention may also be applied to etchant solutions comprising a mixture of two or more organo-silicon compounds.

The method of the invention involves reacting substantially all of the silicon ions in the etchant solution with fluoride ions added in stoichiometric excess, and measuring the concentration of the unreacted fluoride ions, preferably via a fluoride ion specific electrode (FISE). The method of the invention may also be applied to analyze silicon in etchant solutions used to etch materials other than silicon nitride, silicon dioxide, for example.

The method of the invention for determining a concentration of silicon ions in an etchant solution comprising phosphoric acid, an organo-silicon compound and water, comprises the basic steps of: (1) providing a test solution comprising a predetermined volume of the etchant solution; (2) adding a predetermined concentration of a carboxylic acid to the test solution; (3) adding a predetermined concentration of fluoride ions to the test solution in stoichiometric excess of that required to react with substantially all of the silicon ions in the test solution; (4) placing a fluoride ion specific electrode (FISE) and a reference electrode in contact with the test solution; (5) measuring a measured potential of the FISE relative to the reference electrode in the test solution; and (6) determining the concentration of silicon ions in the etchant solution based on the difference in the measured potential and an expected potential for the predetermined concentration of fluoride ions added to the test solution. The FISE and the reference electrode may be separate electrodes or may be combined in a combination electrode.

The predetermined volume of the etching solution may be provided manually, using a syringe, a volumetric flask or a graduated cylinder, for example, or automatically, via an automatic syringe or a metering pump, for example. Fluoride ions may be added as part of any fluoride compound that tends to dissociate in aqueous solution, HF, LiF, NaF, KF, NH₄HF₂, NH₄F, and mixtures thereof, for example. The predetermined concentration of fluoride ions may be added to the test solution as part of a solid compound of known weight, or as a predetermined volume of a standard fluoride solution.

In a preferred embodiment, a predetermined concentration of a fluoride compound is dissolved in a liquid carboxylic acid to form a reagent solution, a predetermined volume of which is added to a predetermined volume of the etchant solution to form the test solution. The etchant solution generally contains water but additional water, although not required, may be added to the reagent solution and/or to the test solution.

The carboxylic acid of the invention may be any compound comprising a carboxylic acid functional group, including compounds comprising multiple carboxylic acid groups or other substituents, an alkyl group, for example. The carboxylic acid is preferably a liquid at room temperature, and may be anhydrous or comprise a predetermined concentration or volume fraction of water. Preferred carboxylic acids include acetic acid, propionic acid and mixtures thereof.

It is understood by those skilled in the art that silicon is present in aqueous solutions in ionic form, the fundamental species being the silicate ion (SiO₃²⁻) which tends to exist as the protonated species HSiO₃⁻ and H₂SiO₃ in acidic solutions. However, since silicon forms a variety of complexes and the exact species formed by dissolution of silicon nitride in a phosphoric acid etchant solution (especially one comprising an organo-silicon compound) at elevated temperature are unknown, the term “silicon concentration” and “concentration of silicon ions” are used to denote the total concentration of all silicon ions in a solution (expressed in ppm). For determining the silicon concentration, the product of the reaction between silicon ions and fluoride ions is assumed to be the hexafluorosilicic ion (SiF₆²⁻) formed by the overall reaction:

H₂SiO₃+6HF=H₂SiF₆+3H₂O

involving the dissociated HF species. In this case, the silicon:fluoride stoichiometric ratio is 1:6 (six fluoride ions are required to react with one silicon species).

The term “fluoride ions” denotes “free” F⁻ ions formed by dissociation of a fluoride compound in aqueous solution. For example, hydrofluoric acid (HF) dissociates according to:

HF=H⁺+F⁻ (1)

providing the free fluoride ions (F⁻) that are detected by a fluoride ion specific electrode (ISE). Under ideal conditions, the potential (E) of a FISE is given by the well-known Nernst equation:

E=Eₒ−(2.303RT/nF)log [F⁻] (2)

where Eₒ is the standard equilibrium potential, R is the natural gas constant, T is the temperature (° K), n is the number of electrons transferred in the electrode reaction, F is the faraday constant, and [F⁻] is the activity of fluoride ions. The value of 2.303 RT/nF is 59 mV/decade for a one-electron reaction at 25° C. Thus, were HF completely dissociated into H⁺ and F⁻ ion, a plot of the potential of a FISE versus log [F⁻] should be linear with a slope of 59 mV/decade. Note that fluorine in HF and other undissociated compounds or ions (SiF₆²⁻ ion, for example) is not detected by the fluoride ISE.

In practice, Nernstian slopes for fluoride detected by a FISE typically deviate somewhat from the theoretical value (59 mV/decade) due to incomplete dissociation of the fluoride compound (HF, for example), variations in the concentrations of other species involved in the equilibrium (H⁺ ion from phosphoric acid, for example), and/or non-ideal solution behavior (non-unity activity coefficients, for example). The potentials of fluoride ion specific electrodes and reference electrodes also exhibit some variability from electrode to electrode and tend to drift with time. Nonetheless, the potential response of the fluoride ion specific electrode in etchant solutions comprising phosphoric acid and an organo-silicon compound, tends to be sufficiently reproducible to provide a reliable measure of the fluoride concentration, and indirectly the silicon concentration.

According to the Nernst equation (Eq. 2), the potential of a FISE in a test solution is directly proportional to the temperature of the test solution. It is therefore preferable that the potential of the FISE in the test solution be measured at constant temperature, or be corrected for fluctuations in the temperature of the test solution. Such temperature corrections can be made using the Nernst equation (Eq. 2).

In one embodiment of the invention, the step of determining the concentration of silicon ions in the etchant solution comprises the steps of (a) determining a concentration of reacted fluoride ions, formed by chemical reaction with silicon ions in the test solution, from the difference in the predetermined and the measured concentrations of fluoride ions in the test solution, and (b) calculating the concentration of silicon ions in the etchant solution from the concentration of reacted fluoride ions in the test solution, the predetermined volume of the etchant solution, and the stoichiometry of the reaction between the silicon ions and the fluoride ions. Possible reactions of organo-silicate compounds with fluoride ions include hydrolysis and fluoridation, for which the silicon:fluoride stoichiometric ratio is 1:1.

In a preferred embodiment, the step of determining the concentration of silicon ions in the etchant solution comprises the steps of (a) generating a calibration curve by measuring the potential of the FISE relative to the reference electrode at a predetermined calibration temperature in at least two calibration solutions having different predetermined concentrations of silicon ions added to a background electrolyte. The background electrolyte preferably comprises the same constituents at substantially the same concentrations (except for silicon ions) as the test solution. The background electrolyte for an advanced silicon nitride etchant, for example, comprises phosphoric acid, fluoride ions, an organo-silicon compound and water.

The calibration curve is preferably a plot of the FISE potential in the test solution at the calibration temperature versus the concentration of silicon ions in the calibration solution. Preferably, the potential of the FISE is measured with the test solution at the calibration temperature, or is corrected for the difference in the temperature of the test solution and the calibration temperature (using the Nernst equation, for example). In this case, the silicon concentration in the etchant solution can be read directly from the calibration curve. For optimum accuracy of the silicon analysis of the invention, the measured FISE potential should also be corrected for variations in the phosphoric acid concentration in the etchant solution.

In a preferred embodiment, the fluoride compound is dissolved in a predetermined volume of the carboxylic acid to form a reagent solution that is added to a predetermined volume of the etchant solution to form the test solution. Although typically not required, a predetermined volume of water may be added to the reagent solution or the test solution.

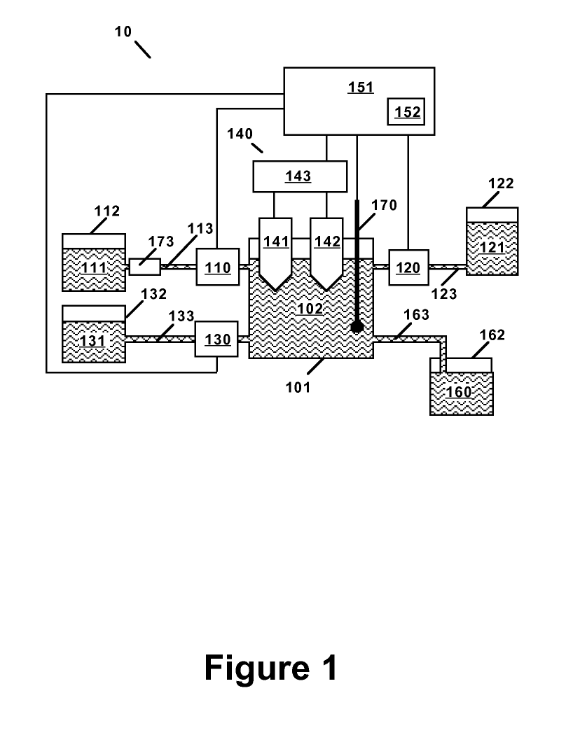

FIG. 1 schematically illustrates an apparatus 10 of the invention for determining a concentration of silicon ions in an etchant solution 111 comprising an organo-silicon compound, phosphoric acid and water, comprising: an analysis cell 101 containing a test solution 102 comprising a predetermined volume of etchant solution 111 and predetermined concentrations of fluoride ions and a carboxylic acid; a means 110 of providing the predetermined volume of etchant solution 111 contained in an etchant container 112; a means 130 of adding the predetermined concentrations of fluoride ions and the carboxylic acid to test solution 102; a means 140 of measuring the concentration of fluoride ions in test solution 102; and a computing device 151 having a memory element 152 with a stored algorithm operative to effect, via appropriate mechanical and electrical interfacing, at least the basic steps of the method of the invention, comprising: providing test solution 102 comprising the predetermined volume of etchant solution 111; adding the predetermined concentrations of fluoride ions and the carboxylic acid to test solution 102; measuring a measured concentration of fluoride ions in test solution 102; and determining the concentration of silicon ions in etchant solution 111 from the difference in the predetermined and the measured concentrations of fluoride ions in test solution 102. Analysis cell 101 may be of any suitable shape, including an open beaker or a closed cell with feedthroughs for the electrodes (as shown in FIG. 1), for example, and may comprise any suitable material, glass or a polyolefin plastic, for example.

Means 110 of providing the predetermined volume of etchant solution 111 contained in a etchant container 112 may comprise a syringe, a volumetric flask or a graduated cylinder, for example, for manual delivery, or an automatic syringe or a metering pump with associated plumbing and wiring, for example, for automatic delivery (as indicated in FIG. 1). Etchant container 112 may be a production etchant tank or an etchant reservoir. For automatic delivery of etchant solution 111, means 110 is connected to a pipe 113 running between etchant container 112 and analysis cell 101.

Fluoride ions may be added to test solution 102 as part of any suitable fluoride compound that tends to dissociate in aqueous solution, HF, LiF, NaF, KF, NH₄HF₂, NH₄F, and mixtures thereof, for example. The predetermined concentration of fluoride ions may be added to test solution 102 as part of a solid compound of known weight, or as a predetermined volume of a reagent solution 131 comprising a standard fluoride solution contained in a reagent reservoir 132 (as indicated in FIG. 1). In a preferred embodiment, the fluoride compound is dissolved in a predetermined volume of the carboxylic acid to form reagent solution 131 that is added to a predetermined volume of the etchant solution to form the test solution. Although typically not required, a predetermined volume of water may be added to reagent solution 131 or test solution 102.

For delivering a predetermined volume of reagent solution 131 from reagent reservoir 132 to test solution 102 in analysis cell 101, means 130 may comprise a syringe, a volumetric flask or a graduated cylinder, for example, for manual delivery, or an automatic syringe or a metering pump with associated plumbing and wiring, for example, for automatic delivery. For automatic delivery of reagent solution 131, means 130 is connected to a pipe 133 running between reagent reservoir 132 and analysis cell 101. Means 130 may include a liquid level sensor (not shown) providing automatic cutoff when the predetermined volume of reagent solution 131 is attained. Means 110 may include a liquid level sensor (not shown) providing automatic cutoff when the predetermined volume of etchant solution 111 is attained.

Apparatus 10 of the invention may further comprise: a dilution device 120 operative to provide metered flow of water 121 from a water reservoir 122 to the analysis cell 101 so as to provide a predetermined volume fraction of water in the test solution. Dilution device 120 may comprise a syringe, a volumetric flask or a graduated cylinder, for example, for manual delivery, or an automatic syringe or a metering pump with associated plumbing and wiring, for example, for automatic delivery (as indicated in FIG. 1). For automatic delivery of water 121, dilution device 120 is connected to a pipe 123 running between water reservoir 122 and analysis cell 101. Preferably, computing device 151 with the stored algorithm is further operative to control dilution device 120.

Means 140 of measuring the concentration of fluoride ions in test solution 102 preferably comprises a fluoride ion specific electrode 141 and a reference electrode 142 in contact with test solution 102, and a voltmeter 143 for measuring the potential between the two electrodes. Suitable reference electrodes and fluoride ion specific electrodes are well-known in the art and are available commercially. Typical reference electrodes include the silver-silver chloride electrode (SSCE), saturated calomel electrode (SCE), mercury-mercury sulfate electrode, for example. A double junction may be used for one or both electrodes to minimize contamination of the electrode solution by etchant solution species (which may cause drift in the electrode potential). Fluoride ion specific electrode 141 and reference electrode 142 may be separate electrodes or may be combined in a combination electrode.

After a fluoride ISE measurement is completed, test solution 102 is preferably flowed via waste pipe 163 into waste container 162 or directly into a waste treatment system (not shown). Between silicon determinations, analysis cell 101 is preferably rinsed with water to minimize cross-contamination errors. Analysis cell 101 may be rinsed using water provided by dilution device 120 or by a separate rinse system (not shown).

Fluoride ISE calibrations and measurements should be performed at a constant temperature, preferably at or near room temperature, and/or FISE potentials should be corrected for significant variations in the temperature of test solution 102. Preferably, the apparatus of the invention further comprises: a temperature sensor 170 for measuring the temperature of test solution 102. Temperature sensor 170 may be of any suitable type, including a thermometer, a thermocouple (as indicated in FIG. 1), a thermistor, or an NIR spectrometer, for example. Preferably, computing device 151 is further operative to acquire temperature data from the temperature sensor 170 and correct the potentials measured for FISE 141 for temperature effects so as to provide a more accurate determination of the concentration of fluoride ions in test solution 102.

Since silicon nitride etchant solutions generally operate at high temperature (>150° C.), a means for rapidly cooling the predetermined volume of etchant solution 111 can significantly shorten the analysis time. Any suitable cooling means may be used. For example, as indicated in FIG. 1, etchant solution 111 flowed from etchant tank 112 to analysis cell 101 may be passed through a cooling device 173, which may comprise a jacketed portion of pipe 113 or a heat radiator device, for example.

The apparatus of the invention preferably includes a means of controlling the temperature of test solution 102 to minimize errors in the measured concentration of fluoride ions in test solution 102. Suitable means of controlling the temperature of a liquid are well-known in the art. For example, a hot plate or an immersion heater with feedback from a temperature sensor may be used to control the temperature of a liquid in an analysis cell. A preferred means of controlling the temperature of test solution 102 is to pass water or another heat exchange liquid from a circulator/controller (or another constant temperature source) through a cooling jacket on analysis cell 101 (not shown).

Computing device 151 may comprise a computer with integrated components, or may comprise separate components, a microprocessor and a memory device that includes memory element 152, for example. Memory element 152 may be any one or a combination of available memory elements, including a computer hard drive, a microprocessor chip, a read-only memory (ROM) chip, a programmable read-only memory (PROM) chip, a magnetic storage device, a computer disk (CD) and a digital video disk (DVD), for example. Memory element 152 may be an integral part of computing device 151 or may be a separate device.

### DESCRIPTION OF A PREFERRED EMBODIMENT

A preferred embodiment of the apparatus of the invention for determining a silicon concentration in an etchant solution comprising phosphoric acid, an organo-silicon compound and water, comprises: an analysis cell containing a test solution comprising a predetermined volume fraction of the etchant solution and a predetermined volume fraction of a reagent solution comprising a predetermined concentration of fluoride ions dissolved in anhydrous acetic acid or propionic acid; a sampling device operative to provide metered flow of the etchant solution through a sample pipe from an etchant tank to the analysis cell so as to provide the predetermined volume fraction of the etchant solution; a reagent device operative to provide metered flow of a reagent solution through a reagent tube from a reagent reservoir to the analysis cell so as to provide the predetermined volume fraction of the reagent solution; a means of measuring the concentration of fluoride ions in the test solution, comprising a fluoride ion specific electrode (FISE) in contact with the test solution in the analysis cell, a reference electrode in contact with the test solution in the analysis cell, and a voltmeter for measuring the potential of the FISE relative to the reference electrode; a temperature sensor for measuring the temperature of the test solution; and a computing device having a memory element with a stored algorithm operative to effect, via appropriate interfacing, the steps of a preferred method of the invention.

With reference to paragraph [0053], the preferred method comprises the steps of: generating a calibration curve of the FISE potential measured at a predetermined calibration temperature in at least two calibration solutions having different predetermined concentrations of silicon ions added to a background electrolyte versus the silicon ion concentration in the calibration solutions; providing the test solution by flowing the predetermined volume fraction of the etchant solution and the predetermined volume fraction of the reagent solution into the analysis cell; maintaining the temperature of the test solution at the calibration temperature; measuring the potential of the FISE relative to the reference electrode in the test solution; and determining the concentration of silicon ions in the etchant solution by comparing the measured potential of the FISE in the test solution with the calibration curve.

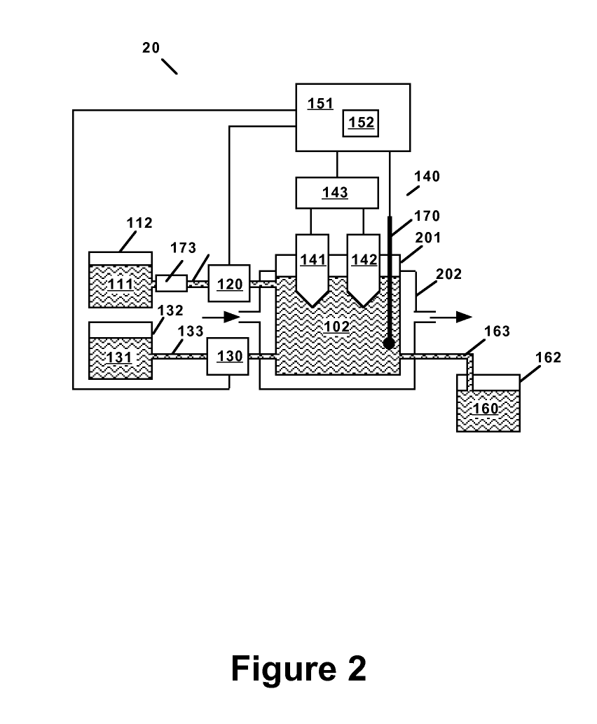

FIG. 2 schematically illustrates a preferred apparatus 20 of the invention for determining a concentration of silicon ions in an etchant solution 111. This preferred apparatus is the same as that depicted in FIG. 1 except that dilution device 120 of FIG. 1 has been omitted, and a cooling jacket 202 is included on analysis cell 201 for maintaining test solution 102 at a predetermined temperature.

The efficacy of the invention for determining the concentration of silicon ions in a silicon nitride etchant solution comprising an organo-silicate compound was demonstrated using standard etchant solutions (provided by Soulbrain Co., Ltd.) comprising various concentrations of an organo-silicate compound (640, 740, 840, 940 and 1040 ppm) dissolved in 85 wt. % H₃PO₄ (15 wt. % water). Tests were performed using reagent solutions comprising 8.0 g/L KF in deionized water (for comparison), 8.0 g/L KF in 100% acetic acid, 10.0 g/L KF in 100% acetic acid or 10.0 g/L KF in 100% propionic acid. In all cases, the test solution comprised 15.0 mL of the reagent solution and 25.0 mL of the etchant solution. The fluoride ion concentration in the test solutions was measured at room temperature using a combination fluoride ion specific electrode/silver-silver chloride reference electrode (4.0 M KCl).

### Example 1

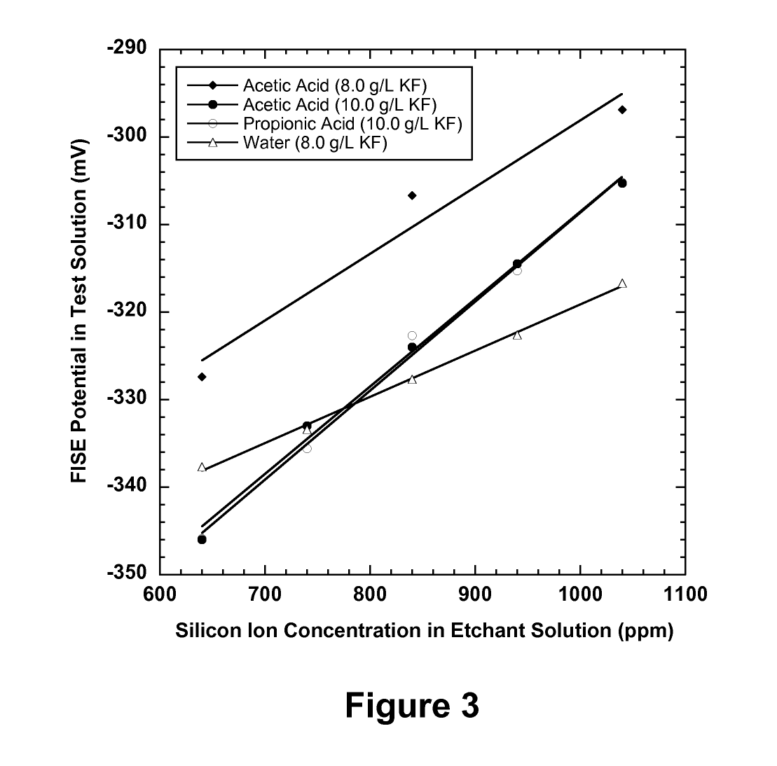

FIG. 3 and Table 1 summarize the results for measurements of the potential of the fluoride ion specific electrode (FISE) as a function of the concentration of silicon ions in the etchant solution for the various reagent solutions. For the reagent solutions comprising 10.0 g/L KF in acetic or propionic acid, the calibration plots in FIG. 1 are linear and practically identical. It is evident that the sensitivity of the FISE potential to the concentration of silicon ions in the etchant solution (as indicated by the slopes of the plots in FIG. 3 and tabulated data in Table 1) is a factor of two greater for the reagent solutions comprising a carboxylic acid (acetic acid or propionic acid) compared to that for the reagent solution not comprising a carboxylic acid. Addition of the reagent solution not comprising a carboxylic acid to the etchant solution also resulted in formation of a precipitate, which reduced the reproducibility of the results, whereas no precipitation was observed for the reagent solutions comprising a carboxylic acid.

TABLE 1
Silicon Ion Sensitivity for Various Reagent Solutions

| | Sensitivity |
|---|---|
| Reagent | (mV/ppm) |
| 8.0 g/L KF in acetic acid | 0.076 |
| 10 g/L KF in acetic acid | 0.103 |
| 10 g/L KF in propionic acid | 0.102 |
| 8.0 g/L KF in deionized water | 0.050 |

### Example 2

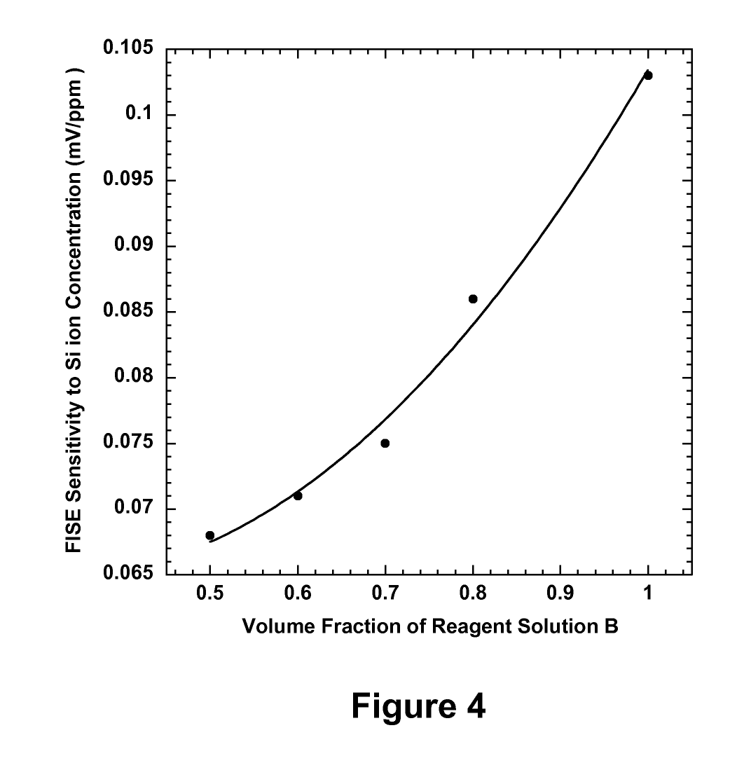

To further illustrate the efficacy of adding a carboxylic acid to the test solution to improve the sensitivity to silicon ions in the etchant solution, a series of reagent solutions comprising 10.0 g/L KF and various volume fractions of water and acetic acid was prepared by mixing a solution A comprising 10.0 g/L KF in water and a solution B comprising 10.0 g/L KF in 100% acetic acid in various proportions. Table 2 and FIG. 4 summarize the results. The sensitivity to the concentration of silicon ions is seen to increase monotonically with increasing volume fraction of reagent solution B comprising acetic acid.

TABLE 2
Silicon Ion Sensitivity for Mixtures of Reagent Solutions A and B

| Solution A Volume | Solution B Volume | Solution B | Sensitivity |
|---|---|---|---|
| (mL) | (mL) | Volume Fraction | (mV/ppm) |
| 0.00 | 15.00 | 1.00 | 0.103 |
| 3.00 | 12.00 | 0.80 | 0.086 |
| 4.50 | 10.50 | 0.70 | 0.075 |
| 6.00 | 9.00 | 0.60 | 0.071 |
| 7.50 | 7.50 | 0.50 | 0.068 |

The preferred embodiments of the present invention have been illustrated and described above. Modifications and additional embodiments, however, will undoubtedly be apparent to those skilled in the art. Furthermore, equivalent elements may be substituted for those illustrated and described herein, parts or connections might be reversed or otherwise interchanged, and certain features of the invention may be utilized independently of other features. Consequently, the exemplary embodiments should be considered illustrative, rather than inclusive, while the appended claims are more indicative of the full scope of the invention.

We claim:

1. A method for determining a concentration of silicon ions in an etchant solution comprising phosphoric acid, an organo-silicon compound and water, comprising the steps of:
providing a test solution comprising a predetermined volume of the etchant solution;
adding a predetermined concentrations of a carboxylic acid to the test solution;
adding a predetermined concentration of fluoride ions to the test solution in stoichiometric excess of that required to react with substantially all of the silicon ions in the test solution;
placing a fluoride ion specific electrode (FISE) and a reference electrode in contact with the test solution;
measuring a measured potential of the FISE relative to the reference electrode; and
determining the concentration of silicon ions in the etchant solution based on the difference in the measured potential and an expected potential for the predetermined concentration of fluoride ions added to the test solution,
wherein the FISE and the reference electrode may be separate electrodes or may be combined in a combination electrode.

2. The method of claim 1, wherein the organo-silicon compound in the etchant solution is selected from the group comprising an organo-silicate compound, a silyl phosphate compound, and mixtures thereof.

3. The method of claim 1, wherein the predetermined concentrations of the carboxylic acid and fluoride ions are added to the test solution by means of a reagent solution comprising a predetermined concentration of fluoride ions dissolved in the carboxylic acid.

4. The method of claim 3, wherein a predetermined volume of water is added to the reagent solution.

5. The method of claim 1, wherein the carboxylic acid is selected from the group consisting of acetic acid, propionic acid, and mixtures thereof.

6. The method of claim 1, wherein the fluoride compound is selected from the group consisting of HF, LiF, NaF, KF, NH₄HF₂, NH₄F, and mixtures thereof.

7. The method of claim 1, wherein the step of determining the concentration of silicon ions in the etchant solution, comprises the steps of
generating a calibration curve by measuring the potential of the FISE relative to the reference electrode at a predetermined calibration temperature in at least two calibration solutions comprising different predetermined concentrations of silicon ions in a background electrolyte of the etchant solution, and
comparing the potential of the FISE measured for the test solution with the calibration curve.

8. The method of claim 1, wherein the step of determining the concentration of silicon ions in the etchant solution comprises the steps of
determining a concentration of reacted fluoride ions, formed by a reaction with silicon ions in the test solution, from the difference in the predetermined and the measured concentrations of fluoride ions in the test solution, and
calculating the concentration of silicon ions in the etchant solution from the concentration of reacted fluoride ions in the test solution, the predetermined volume of the etchant solution, and the stoichiometry of the reaction between the silicon ions and the fluoride ions.

9. The method of claim 7, further comprising the steps of:
measuring a temperature of the test solution; and
correcting the potential measured for the FISE for the effect of a difference in the temperature of the test solution and the predetermined calibration temperature.

10. The method of claim 1, wherein the measured potential of the FISE is corrected for variations in the phosphoric acid concentration in the etchant solution.

11. An apparatus for determining a concentration of silicon ions in an etchant solution comprising phosphoric acid, an organo-silicon compound and water, comprising:
an analysis cell containing a test solution comprising a predetermined volume of the etchant solution and predetermined concentrations of fluoride ions and a carboxylic acid;
a means of providing the predetermined volume of the etchant solution;
a means of adding the predetermined concentrations of fluoride ions and the carboxylic acid to the test solution;
a means of measuring the concentration of fluoride ions in the test solution comprising a fluoride ion specific electrode (FISE) and a reference electrode in contact with the test solution, and a voltmeter for measuring the potential of the FISE relative to the reference electrode; and
a computing device having a memory element with a stored algorithm operative to effect, via appropriate interfacing, at least the basic steps of the method of the invention, comprising
providing the test solution comprising the predetermined volume of the etchant solution,
adding the predetermined concentrations of a carboxylic acid to the test solution,
adding the predetermined concentration of fluoride ions to the test solution in stoichiometric excess of that required to react with substantially all of the silicon ions in the test solution,
placing the fluoride ion specific electrode (FISE) and the reference electrode in contact with the test solution,
measuring a measured potential of the FISE relative to the reference electrode, and
determining the concentration of silicon ions in the etchant solution based on the difference in the measured potential and the expected potential for the predetermined concentration of fluoride ions in the test solution,
wherein the FISE and the reference electrode may be separate electrodes or may be combined in a combination electrode, and fluoride ions are added to the test solution as part of a fluoride compound.

12. The apparatus of claim 11, wherein the memory element is selected from the group consisting of computer hard drive, microprocessor chip, read-only memory (ROM) chip, programmable read-only memory (PROM) chip, magnetic storage device, computer disk (CD) and digital video disk (DVD).

13. The apparatus of claim 11, further comprising:
a temperature sensor for measuring the temperature of the test solution,
wherein the computing device is further operative to acquire temperature data from the temperature sensor and correct the potential measured for the FISE for a temperature effect.

14. The apparatus of claim 13, further comprising:
a means of maintaining the temperature of the test solution at a predetermined temperature.

15. The apparatus of claim 11, further comprising:
a sampling device operative to flow a predetermined volume of the etchant solution from an etchant container to the analysis cell; and
a reagent device operative to flow a predetermined volume of a reagent solution comprising a predetermined concentration of the fluoride compound dissolved in the carboxylic acid from a reagent reservoir to the analysis cell,
wherein said computing device with the stored algorithm is further operative to control the sampling device and the reagent device.

16. The apparatus of claim 11, further comprising:
a means of rapidly cooling the test solution to a predetermined temperature.

17. An apparatus for determining a concentration of silicon ions in an etchant solution comprising phosphoric acid, an organo-silicon compound and water, comprising:
an analysis cell containing a test solution comprising a predetermined volume fraction of the etchant solution and a predetermined volume fraction of a reagent solution comprising predetermined concentrations of fluoride ions and a carboxylic acid;
a sampling device operative to provide metered flow of the etchant solution from an etchant container to the analysis cell so as to provide the predetermined volume fraction of the etchant solution;
a reagent device operative to provide metered flow of the reagent solution from a reagent reservoir to the analysis cell so as to provide the predetermined volume fraction of the reagent solution;
a means of measuring the concentration of fluoride ions in the test solution comprising
a fluoride ion specific electrode (FISE) in contact with the test solution in the analysis cell,
a reference electrode in contact with the test solution in the analysis cell, and
a voltmeter for measuring the potential of the FISE relative to the reference electrode;
a means of maintaining the test solution in the analysis cell at a predetermined temperature; and
a computing device having a memory element with a stored algorithm operative to effect, via appropriate interfacing, the steps of the method of the invention, comprising
generating a calibration curve by measuring the potential of the FISE relative to the reference electrode at a predetermined calibration temperature in at least two calibration solutions having different predetermined concentrations of silicon ions,
providing the test solution by flowing the predetermined volume fraction of the etchant solution and the predetermined volume fraction of the reagent solution into the analysis cell,
maintaining the temperature of the test solution at the calibration temperature,
measuring the potential of the FISE relative to the reference electrode in the test solution, and
determining the concentration of silicon ions in the etchant solution by comparing the measured potential of the FISE in the test solution with the calibration curve.

18. The apparatus of claim 17, further comprising:
a dilution device operative to provide metered flow of water from a water reservoir to the analysis cell so as to provide a predetermined volume fraction of water in the test solution,
wherein said computing device with the stored algorithm is further operative to control the dilution device.

19. The apparatus of claim 17, wherein the sampling device provides flow of the etchant solution at a predetermined etchant solution flow rate through the analysis cell, and the reagent device provides flow of the reagent solution at a predetermined reagent solution flow rate through the analysis cell, whereby the silicon concentration in the etchant solution may be determined continuously.
